(19) United States
(12) Patent Application Publication
(10) Pub. No.: US 2007/0284316 A1
(43) Pub. Date: Dec. 13, 2007

(54) Cooling water reforming method and cooling apparatus

(75) Inventors: Kazuyuki Yamasaki, Hiroshima-shi (JP); Masaki Kataoka, Fukuyama-shi (JP); Kazumi Chuhjoh, Takamatsu-shi (JP); Shiroh Imazu, Kasaoka-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/802,475

(22) Filed: May 23, 2007

(30) Foreign Application Priority Data
Jun. 7, 2006 (JP) P2006-158821

(51) Int. Cl. C02F 1/78; C02F 1/02

(52) U.S. Cl. 210/760; 210/177

(57) ABSTRACT

A cooling water reforming method of the invention includes making ozone micro/nanobubbles contained in cooling water in a cooling tower. A cooling apparatus of the invention includes an ozone micro/nanobubble generation section for generating ozone micro/nanobubbles in cooling water in a cooling tower so as to make ozone micro/nanobubbles contained in the cooling water. The ozone micro/nanobubble generation section includes an ozone generator for generating ozone, and a micro/nanobubble generator for generating ozone micro/nanobubbles in the cooling water by using the ozone.

### CROSS-REFERENCE TO RELATED APPLICATIONS

This Nonprovisional application claims priority under 35 U.S.C. §119(a) on Patent Application No. 2006-158821 filed in Japan on Jun. 7, 2006, the entire contents of which are hereby incorporated by reference.

### BACKGROUND OF THE INVENTION

The present invention relates to a cooling water reforming method, which is a method for improving the water quality of cooling water. More particularly, the invention relates to a method for maintaining cooling water in a desirable state in a cooling tower.

The invention also relates to a cooling apparatus for embodying such a cooling water reforming method.

The cooling tower is a kind of heat exchanger which is placed outdoors to make water or some other heating medium brought into direct or indirect contact with the atmospheric air and thereby cooled, and which has been in use in many industries. Generally, cooling water, which is a heating medium in the cooling tower, is suitable for propagation of microorganisms such as bacteria and amoebae in terms of water temperature, with a high likelihood of increases of Legionella bacteria. For this reason, it is often the case that sterilizers (chlorinated pesticides etc.) are continually added to suppress the propagation of Legionella bacteria or other microorganisms during periods of use of the cooling tower. Excessively enriched cooling water would cause scale, slime or corrosion to occur within the cooling apparatus, making the cleaning and sterilization effects lost. Therefore, as a countermeasure therefor, the enrichment is suppressed by forced blowing of the cooling water and resupplying of water. Another measure is to charge chemicals for prevention of scale, slime and corrosion at proper concentrations. Thus, keeping the cooling water in a desirable state in the cooling tower involves high technologies.

In this connection, JP 2004-121962 A describes a method and apparatus intended for use of nanobubbles by making use of properties of nanobubbles such as decreases in buoyancy, increases in surface area, increases in surface activity, generation of local high-pressure fields, and surface activation function, bactericidal action or the like by implementation of electrostatic polarization. More specifically, it is described that inter-associations of those properties allow various kinds of objects to be cleaned with high functions and low environmental loads by the adsorption function for contamination components, high-speed cleaning function for surfaces of the objects and the bactericidal function so that polluted water can be purified.

Also, JP 2003-334548 A describes a method of generating nanobubbles including a step of, in a liquid, decomposing and gasifying part of the liquid, a step of applying ultrasonic waves in the liquid, or steps of decomposing and gasifying part of the liquid and applying ultrasonic waves.

Also, JP 2004-321959 A describes a waste water treatment apparatus making use of ozone microbubbles, in which ozone gas generated from an ozone generator as well as waste water discharged out from lower portion of a treatment tank are supplied to a microbubble generator via a booster pump. It is also described that the generated ozone microbubbles are passed through an opening of a gas blowoff pipe into the waste water in the treatment tank.

It is noted here that the term “microbubbles” is defined as “air bubbles which have diameters ranging from 10 μm to several 10's of μm upon their generation.” Microbubbles shrink after their generation to change into “micro/nanobubbles.”

The term “micro/nanobubbles” refers to air bubbles having diameters ranging from several hundreds of nm to 10 μm.

The term “nanobubbles” refers to air bubbles having diameters of several hundreds of nm or less.

### SUMMARY OF THE INVENTION

However, none of above-described JP 2004-121962 A, JP 2003-334548 A and JP 2004-321959 A discloses any technique for keeping cooling water in a desirable state in the cooling tower.

Accordingly, an object of the present invention is to provide a cooling water reforming method capable of keeping cooling water in a desirable state in the cooling tower. More specifically, the cooling water reforming method according to the present invention is capable of i) suppressing occurrence of scale, slime (including that due to microorganisms and algae) and corrosion, ii) in conjunction with this, reducing water treatment chemicals for cooling water, and iii) increasing the efficiency of heat exchange (thermal efficiency) associated with coils of the cooling tower so that an energy saving can be achieved.

Another object of the present invention is to provide a cooling apparatus for embodying such a cooling water reforming method.

In order to achieve the object, a cooling water reforming method according to the present invention includes a step of making ozone micro/nanobubbles contained in cooling water in a cooling tower.

It is noted here that the term “ozone micro/nanobubbles” refers to micro/nanobubbles containing ozone.

The present inventor found out that the cooling water reforming method of the invention is capable of, with regard to cooling water in the cooling tower, effectively i) suppressing occurrence of scale, slime (including that due to microorganisms and algae) and corrosion, ii) in conjunction with this, reducing water treatment chemicals for cooling water, and iii) increasing the efficiency of heat exchange (thermal efficiency) associated with coils (heat exchanger pipes) of the cooling tower so that an energy saving can be achieved.

In this case, the effect for preventing occurrence of scale and slime can be obtained to some extent even by a method in which air micro/nanobubbles (which mean micro/nanobubbles formed of air) are made to be contained in the cooling water. However, the present inventor found out that the method including the step of making ozone micro/nanobubbles contained in the cooling water has a larger effect.

A cooling apparatus according to the present invention comprises an ozone micro/nanobubble generation section for generating ozone micro/nanobubbles in cooling water in a cooling tower so as to make ozone micro/nanobubbles contained in the cooling water.

With the cooling apparatus of this invention, the cooling water reforming method described above can be embodied. That is, ozone micro/nanobubbles can be made to be contained in the cooling water in the cooling tower. Therefore, according to the cooling apparatus of the invention, with regard to the cooling water in the cooling tower, it is effectively achievable i) to suppress occurrence of scale, slime (including that due to microorganisms and algae) and corrosion, ii) in conjunction with this, to reduce water treatment chemicals for the cooling water, and iii) to increase the efficiency of heat exchange (thermal efficiency) associated with coils of the cooling tower so that an energy saving can be achieved. That is, it is achievable to keep the cooling water in a desirable state in the cooling tower.

In the cooling apparatus of one embodiment, the ozone micro/nanobubble generation section comprises an ozone generator for generating ozone, and a micro/nanobubble generator for generating ozone micro/nanobubbles in the cooling water by using the ozone.

In the cooling apparatus of this one embodiment, the ozone generator generates ozone, and the micro/nanobubble generator generates ozone micro/nanobubbles in the cooling water by using the ozone. As a result, ozone micro/nanobubbles can be made to be contained in the cooling water in the cooling tower.

In the cooling apparatus of one embodiment,

the cooling tower comprises: a sprinkle water storage tank, placed in an upper portion, for storing the cooling water; a water sprinkling portion, placed in an intermediate portion, for sprinkling cooling water derived from the sprinkle water storage tank; and a main water tank, placed in a lower portion, for collecting and storing cooling water sprinkled by the water sprinkling portion, the cooling apparatus further comprising:

a first pump portion for transferring the cooling water of the main water tank to the sprinkle water storage tank, wherein

the micro/nanobubble generator generates ozone micro/nanobubbles in the cooling water of the main water tank.

In the cooling apparatus of this one embodiment, the cooling water in the main water tank is transferred to the sprinkle water storage tank by the first pump portion, and the cooling water derived from the sprinkle water storage tank is sprinkled by the sprinkling portions, being cooled by direct or indirect contact with the atmospheric air. Thereafter, the cooling water returns to the main water tank. In this way, the cooling water circulates through the upper portion, the intermediate portion and the lower portion of the cooling tower. Thus, by the micro/nanobubble generator generating ozone micro/nanobubbles in the cooling water of the main water tank, ozone micro/nanobubbles can be made to be contained in the whole cooling water that circulates through the upper portion, the intermediate portion and the lower portion of the cooling tower. As a result, the cooling water as a whole can be kept in a desirable state.

In the cooling apparatus of one embodiment,

the cooling tower comprises: a sprinkle water storage tank, placed in an upper portion, for storing the cooling water; a water sprinkling portion, placed in an intermediate portion, for sprinkling cooling water derived from the sprinkle water storage tank to outer peripheral surfaces of a plurality of heat exchanger pipes; and a main water tank, placed in a lower portion, for collecting and storing cooling water sprinkled by the water sprinkling portion, the cooling apparatus further comprising:

a first pump portion for transferring the cooling water of the main water tank to the sprinkle water storage tank, wherein

a microorganism carrier for allowing microorganisms to propagate is housed in each of the sprinkle water storage tank and the main water tank.

In the cooling apparatus of this one embodiment, the cooling water in the main water tank is transferred to the sprinkle water storage tank by the first pump portion, and the cooling water derived from the sprinkle water storage tank is sprinkled to outer peripheral surfaces of the plurality of heat exchanger pipes by the sprinkling portions. The cooling water sprinkled to the outer peripheral surfaces of the heat exchanger pipes absorbs heat from the heating medium within the heat exchanger pipes, while being cooled by direct or indirect contact with the atmospheric air. Thereafter, the cooling water returns to the main water tank. In this way, the cooling water circulates through the upper portion, the intermediate portion and the lower portion of the cooling tower. Thus, by the micro/nanobubble generator generating ozone micro/nanobubbles in the cooling water of the main water tank, ozone micro/nanobubbles can be made to be contained in the whole cooling water that circulates through the upper portion, the intermediate portion and the lower portion of the cooling tower. As a result, the cooling water as a whole can be kept in a desirable state.

The present inventor also found out that even with ozone micro/nanobubbles contained in the cooling water, setting the ozone content to an appropriate one allows microorganisms to propagate on the microorganism carrier. That is, in the cooling apparatus of this one embodiment, microorganisms propagate only at places in the circulation path of the cooling water where the microorganism carrier housed in the sprinkle water storage tank and the main water tank, respectively, are present, producing an effect for subjecting the cooling water to biological water treatment. Accordingly, it becomes possible to reduce water treatment chemicals for the cooling water. Also, since the cooling water is subjected to biological water treatment by those microorganisms, it is less likely that algae and slime due to algae occur in the cooling water. Thus, decreases in thermal efficiency of the heat exchanger pipes can be prevented, so that an energy saving can be achieved.

In the cooling apparatus of one embodiment, the microorganism carrier is a string-type or ring-type polyvinylidene chloride material.

In the cooling apparatus of this one embodiment, since the string-type or ring-type polyvinylidene chloride material is relatively larger in surface area, microorganisms easily propagate so that an effect for subjecting the cooling water to biological water treatment can be obtained.

In the cooling apparatus of one embodiment, the microorganism carrier is activated carbon contained in a meshed bag.

In the cooling apparatus of this one embodiment, since the activated carbon is relatively larger in surface area, microorganisms easily propagate so that an effect for subjecting the cooling water to biological water treatment can be obtained. In particular, it is a large effect that the activated carbon adsorbs organic matters in the cooling water and allows the adsorbed organic matters to be thereafter decomposed by the microorganisms that have propagated in the activated carbon. Accordingly, it becomes possible to reduce water treatment chemicals for the cooling water.

In the cooling apparatus of one embodiment,

the cooling tower comprises: a sprinkle water storage tank, placed in an upper portion, for storing the cooling water; a water sprinkling portion, placed in an intermediate portion, for sprinkling cooling water derived from the sprinkle water storage tank; and a main water tank, placed in a lower portion, for collecting and storing cooling water sprinkled by the water sprinkling portion, the cooling apparatus further comprising:

a first pump portion for transferring the cooling water of the main water tank to the sprinkle water storage tank,

a first auxiliary water tank placed outside the cooling tower, and

a second pump portion for circulating the cooling water between the cooling tower and the first auxiliary water tank, wherein

the micro/nanobubble generator generates ozone micro/nanobubbles in the cooling water of the first auxiliary water tank.

In the cooling apparatus of this one embodiment, the cooling water in the main water tank is transferred to the sprinkle water storage tank by the first pump portion, and the cooling water derived from the sprinkle water storage tank is sprinkled by the sprinkling portions, being cooled by direct or indirect contact with the atmospheric air. Thereafter, the cooling water returns to the main water tank. In this way, the cooling water circulates through the upper portion, the intermediate portion and the lower portion of the cooling tower. Along with this, the cooling water is circulated between the cooling tower and the first auxiliary water tank by the second pump portion. Thus, by the micro/nanobubble generator generating ozone micro/nanobubbles in the cooling water of the first auxiliary water tank, ozone micro/nanobubbles can be made to be contained in the whole cooling water that circulates along the circulation path through the upper portion, the intermediate portion and the lower portion of the cooling tower, as well as along the circulation path between the cooling tower and the first auxiliary water tank. As a result, the cooling water as a whole can be kept in a desirable state.

The cooling apparatus of one embodiment further comprises a second auxiliary water tank interposed on a circulation path of the cooling water between the cooling tower and the first auxiliary water tank, wherein

a microorganism carrier for allowing microorganisms to propagate is housed in the second auxiliary water tank.

In the cooling apparatus of this one embodiment, microorganisms propagate only at places in the two circulation paths of the cooling water where the microorganism carrier housed in the second auxiliary water tank is present, producing an effect for subjecting the cooling water to biological water treatment. Accordingly, it becomes possible to reduce water treatment chemicals for the cooling water. Also, since the cooling water is subjected to biological water treatment by those microorganisms, it is less likely that algae and slime due to algae occur in the cooling water. Thus, decreases in thermal efficiency of the heat exchanger pipes can be prevented, so that an energy saving can be achieved.

In the cooling apparatus of one embodiment, the microorganism carrier is a string-type or ring-type polyvinylidene chloride material.

In the cooling apparatus of this one embodiment, since the string-type or ring-type polyvinylidene chloride material is relatively larger in surface area, microorganisms easily propagate so that an effect for subjecting the cooling water to biological water treatment can be obtained.

In the cooling apparatus of one embodiment, the microorganism carrier is activated carbon contained in a meshed bag.

In the cooling apparatus of this one embodiment, since the activated carbon is relatively larger in surface area, microorganisms easily propagate so that an effect for subjecting the cooling water to biological water treatment can be obtained. In particular, it is a large effect that the activated carbon adsorbs organic matters in the cooling water and allows the adsorbed organic matters to be thereafter decomposed by the microorganisms that have propagated in the activated carbon. Accordingly, it becomes possible to reduce water treatment chemicals for the cooling water.

In the cooling apparatus of one embodiment, the micro/nanobubble generator is a submerged pump type micro/nanobubble generator.

In the cooling apparatus of this one embodiment, ozone micro/nanobubbles can be made to be contained at large amounts in the cooling water in the cooling tower.

In the cooling apparatus of one embodiment, the ozone generator is fitted at a gas suction portion of the submerged pump type micro/nanobubble generator.

In the cooling apparatus of this one embodiment, since the micro/nanobubble generation section is integrally provided, the system becomes simpler, advantageous for management.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a view schematically showing a construction of a cooling apparatus according to a first embodiment of the present invention;

FIG. 2 is a view schematically showing a construction of a cooling apparatus according to a second embodiment of the present invention;

FIG. 3 is a view schematically showing a construction of a cooling apparatus according to a third embodiment of the present invention;

FIG. 4 is a view schematically showing a construction of a cooling apparatus according to a fourth embodiment of the present invention;

FIG. 5 is a view schematically showing a construction of a cooling apparatus according to a fifth embodiment of the present invention;

FIG. 6 is a view schematically showing a construction of a cooling apparatus according to a sixth embodiment of the present invention;

FIG. 7 is a view schematically showing a construction of a cooling apparatus according to a seventh embodiment of the present invention;

FIG. 8 is a view schematically showing a construction of a cooling apparatus according to a eighth embodiment of the present invention.

### DETAILED DESCRIPTION OF THE INVENTION

Hereinbelow, the present invention will be described in detail by way of embodiments thereof illustrated in the accompanying drawings.

### First Embodiment

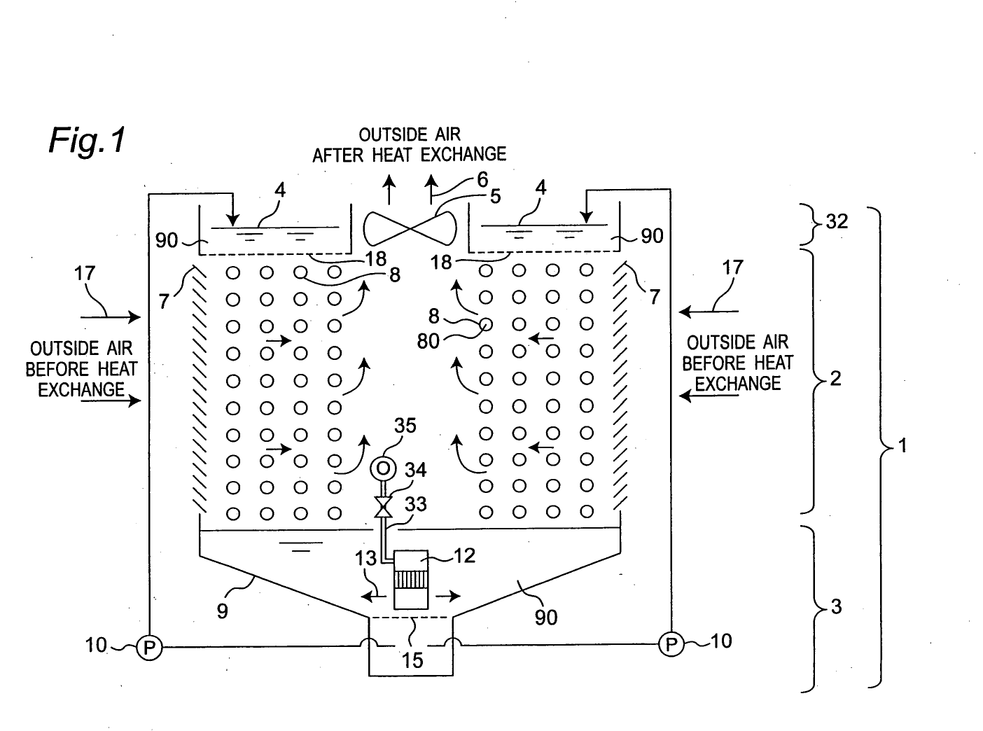

FIG. 1 schematically shows a construction of a cooling apparatus according to a first embodiment of the invention.

This cooling apparatus includes a cooling tower 1, which is divided into an upper portion 32, an intermediate portion 2, and a lower portion 3.

In the upper portion 32 are provided an annular sprinkle water storage tank 4 for storing cooling water, and a fan 5 placed at a center surrounded by the sprinkle water storage tank 4.

In the intermediate portion 2 are provided sprinkling ports 18 as water sprinkling portions provided at a lower portion of the sprinkle water storage tank 4, a multiplicity of heat exchanger pipes 8 placed below the sprinkling ports 18 and formed from copper into a coil shape, and a louver 7 for prevention of cooling water scattering which is so placed as to surround outsides of the heat exchanger pipes 8 and serve as a side wall of the cooling tower. There is a space in central portion of the intermediate portion 2.

The sprinkling ports 18 are formed as numerous small holes so that cooling water 90 can be sprinkled as evenly as possible to outer peripheral surfaces of the heat exchanger pipes 8. Through those small holes, the cooling water 90 drops so as to be sprinkled to the heat exchanger pipes 8.

In this case, it is assumed that water 80 as a heating medium higher in temperature than outside air is flowing inside the heat exchanger pipes 8.

In the lower portion 3 are provided a main water tank 9 for collecting and storing the cooling water 90 sprinkled by the sprinkling ports 18, and a submerged pump type micro/nanobubble generator 12 placed on a porous plate 15 inside the main water tank 9. Outside the main water tank 9 is provided a sprinkler pump 10 as a first pump portion for sucking the cooling water 90 from a portion of the main water tank 9 below the porous plate 15 and transferring the cooling water 90 to the sprinkle water storage tank 4. The discharge rate of flow of the sprinkler pump 10 can be so set that the circulating water amount for the main water tank 9 becomes 1 rotation per hour.

The porous plate 15 may be formed of either stainless or plastic material without any particular limitations on its material.

At a gas suction portion of the submerged pump type micro/nanobubble generator 12, an ozone generator 35 is integrally fitted via an ozone suction pipe 33 and a valve 34 for regulation of ozone generation amount. These components 12, 33, 34, 35 constitute a micro/nanobubble generation section. The ozone generator 35 may be set to such performance that the concentration of ozone within the main water tank 9 falls within a range of 2 ppm to 5 ppm.

As compared with a common micro/nanobubble generation system composed of a known micro/nanobubble generator (not shown) and a circulating pump (not shown), this micro/nanobubble generation section is simpler in its system and moreover capable of generating larger amounts of micro/nanobubbles on a water stream 13 by virtue of its adoption of the submerged pump type micro/nanobubble generator 12.

It is advantageous for a cooling apparatus that the micro/nanobubble generation section is provided as a simpler system from a management point of view as well.

Further, the submerged pump type micro/nanobubble generator 12 is larger in terms of suction amount for generation of micro/nanobubbles, compared to a common micro/nanobubble generation system composed of a known micro/nanobubble generator (not shown) and a circulating pump (not shown). Therefore, the amount of circulating water becomes larger, preferably.

In operation of the cooling apparatus, the sprinkler pump 10 is driven, so that the cooling water 90 is transferred to the sprinkle water storage tank 4 from a portion of the main water tank 9 below the porous plate 15. The cooling water 90 temporarily stored in the sprinkle water storage tank 4 is sprinkled through the sprinkling ports 18 to the outer peripheral surfaces of the multiplicity of heat exchanger pipes 8. Concurrently with this, the fan 5 set in the upper portion 32 is rotated to make an upward air current. By this rotation of the fan 5, outside air before heat exchange 17 passes through the louver 7 in the intermediate portion 2 so as to be introduced to the zone where the heat exchanger pipes 8 are disposed. The cooling water 90 sprinkled to the outer peripheral surfaces of the heat exchanger pipes 8 absorbs heat from the water 80 within the heat exchanger pipes 8 while being cooled by direct contact with the outside air before heat exchange 17, i.e., with the atmospheric air. Thereafter, the cooling water 90 returns to the main water tank 9. In the way shown above, the cooling water 90 circulates through the upper portion 32, the intermediate portion 2 and the lower portion 3 of the cooling tower. The air, as outside air after heat exchange 6, is discharged upward of the cooling tower 1 by the rotation of the fan 5.

Thus, by the outside air, the water 80 within the heat exchanger pipes 8 is cooled via the cooling water 90.

Along with this, the ozone generator 35 and the submerged pump type micro/nanobubble generator 12 are driven during the operation of the cooling apparatus. As a result, ozone is generated by the ozone generator 35, and ozone micro/nanobubbles are generated in the cooling water 90 with use of the ozone by the micro/nanobubble generator 12. Thus, ozone micro/nanobubbles can be made to be contained in the whole cooling water 90 that circulates through the upper portion 32, the intermediate portion 2 and the lower portion 3 of the cooling tower 1.

It is noted here that the term “micro/nanobubbles” refers to air bubbles having diameters of several hundreds of nm to 10 μm. The term “microbubbles” is defined as “air bubbles which have diameters ranging from 10 μm to several 10's of μm upon their generation.” Microbubbles shrink after their generation to change into “micro/nanobubbles.” A portion of microbubbles go shrinking to finally disappear (completely dissolve). The term “nanobubbles” refers to air bubbles having diameters of several hundreds of nm or less (typically, 100 to 200 nm). The term “micro/nanobubbles” can be explained as bubbles in which microbubbles and nanobubbles are mixed together.

In general, there is a tendency that a long term of operation would cause scale, slime or the like to deposit at wetted portions of the heat exchanger pipes 8, the louver 7 and the like. However, in this cooling apparatus, ozone micro/nanobubbles are contained in the cooling water 90 as described above. Accordingly, with regard to the wetted portions of the cooling water 90, it is effectively achievable i) to suppress occurrence of scale, slime (including that due to microorganisms and algae) and corrosion, ii) in conjunction with this, to reduce water treatment chemicals for the cooling water 90, and iii) to increase the efficiency of heat exchange (thermal efficiency) associated with coils of the cooling tower so that an energy saving can be achieved. That is, it is achievable to keep the cooling water 90 in a desirable state in the cooling tower 1.

In particular, the effect for suppressing the occurrence and deposition of scale, slime and the like can be obtained not only in the heat exchanger pipes 8 and the louver 7 but also in the sprinkle water storage tank 4 of the upper portion 32 and the main water tank 9. As a result, it becomes possible, for example, to greatly reduce the number of times of maintenance for cleaning the small holes 18 of the sprinkle water storage tank 4. It also becomes possible to greatly reduce the number of times of maintenance for cleaning the main water tank 9.

In addition, the submerged pump type micro/nanobubble generator 12 is given in this case by one made by Nomura Electronics Co., Ltd. However, those commercially available may be widely used without limitations on their manufacturers.

### Second Embodiment

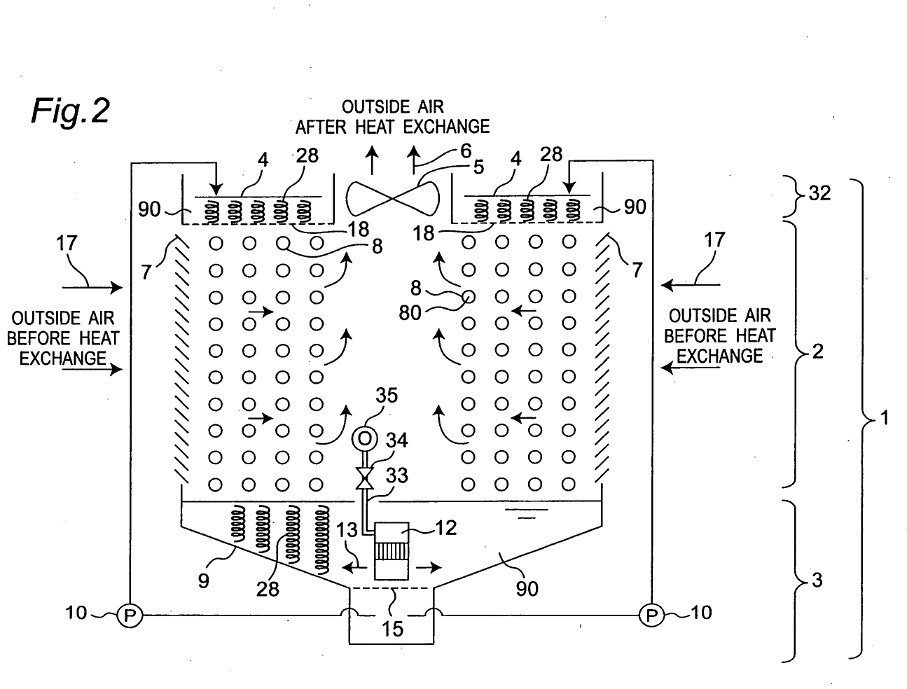

FIG. 2 schematically shows a construction of a cooling apparatus according to a second embodiment of the invention.

The cooling apparatus of the second embodiment differs from that of the first embodiment in that a string-type polyvinylidene chloride material 28 as a microorganism carrier is housed in each of the sprinkle water storage tank 4 and the main water tank 9. Therefore, in FIG. 2, the same components as in FIG. 1 are designated by the same reference numerals, and their detailed description is omitted.

In the cooling apparatus of this second embodiment, the string-type polyvinylidene chloride material 28 having a relatively large surface area is housed in each of the sprinkle water storage tank 4 and the main water tank 9. Therefore, as the operating time elapses, microorganisms propagate only at places in the circulation path of the cooling water 90 where the string-type polyvinylidene chloride material 28 housed in the sprinkle water storage tank 4 and the main water tank 9, respectively, is present. These microorganisms are activated by micro/nanobubbles to produce an effect for subjecting the cooling water 90 to biological water treatment. Accordingly, it becomes possible to reduce water treatment chemicals for the cooling water 90. Also, since the cooling water 90 is subjected to biological water treatment by those microorganisms, it is less likely that algae and slime due to algae occur in the cooling water 90. Thus, decreases in thermal efficiency of the heat exchanger pipes can be prevented, so that an energy saving can be achieved.

In the case of this cooling apparatus, since there is no inflow of waste organic matters unlike the case of waste water treatment, microorganisms propagating in the cooling water 90 are lower in concentration than those of waste water treatment. As a result of such low concentration of microorganisms, microorganisms propagate concentratedly on the string-type polyvinylidene chloride material 28. Then, by the microorganisms that have propagated concentratedly on the string-type polyvinylidene chloride material 28 and been activated by micro/nanobubbles, the water treatment of the cooling water 90 is carried out. As a consequence, the cooling water 90 can be kept in a desirable state in the cooling tower 1, so that deposition of scale and slime can be suppressed.

### Third Embodiment

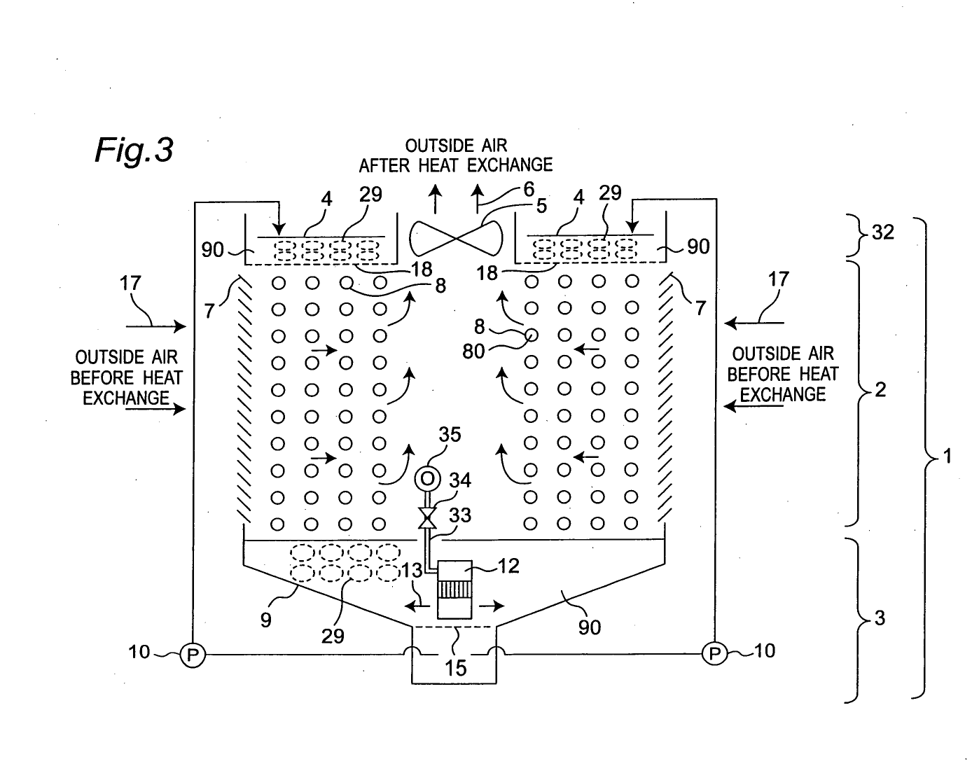

FIG. 3 schematically shows a construction of a cooling apparatus according to a third embodiment of the invention.

The cooling apparatus of this third embodiment differs from that of the first embodiment only in that a ring-type polyvinylidene chloride material 29 as a microorganism carrier is housed in each of the sprinkle water storage tank 4 and the main water tank 9. Therefore, in FIG. 3, the same components as in FIG. 1 are designated by the same reference numerals, and their detailed description is omitted.

In the cooling apparatus of this third embodiment, a ring-type polyvinylidene chloride material 29 having a relatively large surface area is housed in each of the sprinkle water storage tank 4 and the main water tank 9. Therefore, as the operating time elapses, microorganisms propagate only at places in the circulation path of the cooling water 90 where the ring-type polyvinylidene chloride material 29 housed in the sprinkle water storage tank 4 and the main water tank 9, respectively, is present. These microorganisms are activated by micro/nanobubbles to produce an effect for subjecting the cooling water 90 to biological water treatment. Accordingly, it becomes possible to reduce water treatment chemicals for the cooling water 90. Also, since the cooling water 90 is subjected to biological water treatment by those microorganisms, it is less likely that algae and slime due to algae occur in the cooling water 90. Thus, decreases in thermal efficiency of the heat exchanger pipes can be prevented, so that an energy saving can be achieved.

In the case of this cooling apparatus, since there is no inflow of waste organic matters unlike the case of waste water treatment, microorganisms propagating in the cooling water 90 are lower in concentration than those of waste water treatment. As a result of such low concentration of microorganisms, microorganisms propagate concentratedly on the ring-type polyvinylidene chloride material 29. Then, by the microorganisms that have propagated concentratedly on the ring-type polyvinylidene chloride material 29 and been activated by micro/nanobubbles, the water treatment of the cooling water 90 is carried out. As a consequence, the cooling water 90 can be kept in a desirable state in the cooling tower 1, so that deposition of scale and slime can be suppressed.

### Fourth Embodiment

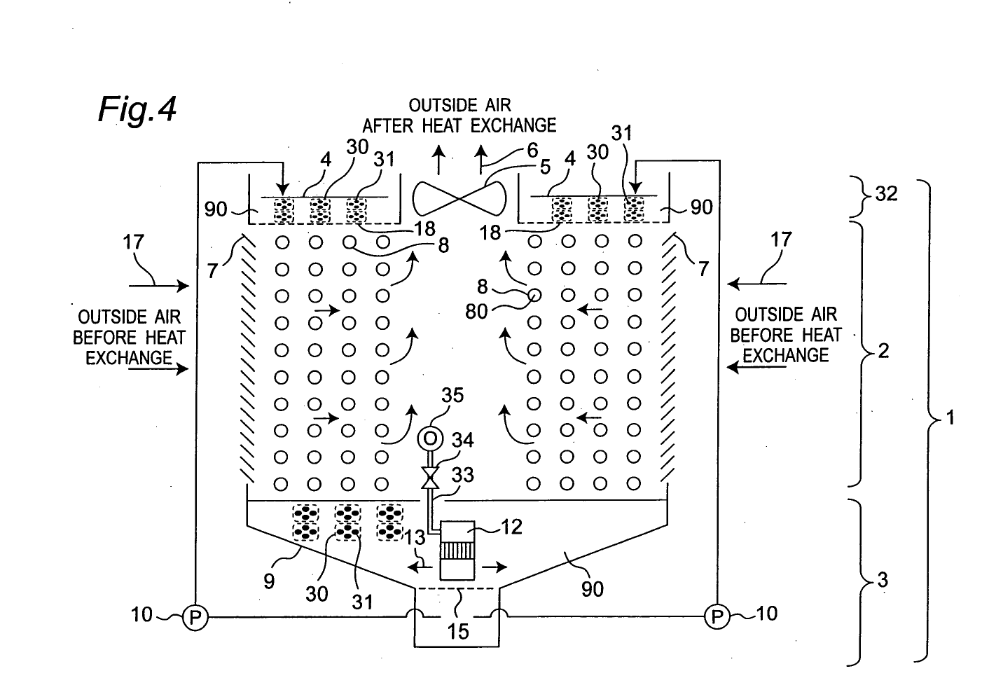

FIG. 4 schematically shows a construction of a cooling apparatus according to a fourth embodiment of the invention.

The cooling apparatus of this fourth embodiment differs from that of the first embodiment only in that activated carbon 31 as a microorganism carrier contained in meshed bags 30 is housed in each of the sprinkle water storage tank 4 and the main water tank 9. Therefore, in FIG. 4, the same components as in FIG. 1 are designated by the same reference numerals, and their detailed description is omitted.

In the cooling apparatus of this fourth embodiment, the activated carbon 31 contained in the meshed bags 30 is housed in each of the sprinkle water storage tank 4 and the main water tank 9. Therefore, as the operating time elapses, microorganisms propagate only at places in the circulation path of the cooling water 90 where the activated carbon 31 housed in the sprinkle water storage tank 4 and the main water tank 9, respectively, is present. These microorganisms are activated by micro/nanobubbles to produce an effect for subjecting the cooling water 90 to biological water treatment. In particular, it is a large effect that the activated carbon 31 adsorbs organic matters in the cooling water 90 and allows the adsorbed organic matters to be thereafter decomposed by the microorganisms that have propagated in the activated carbon. Accordingly, it becomes possible to reduce water treatment chemicals for the cooling water 90. Also, since the cooling water 90 is subjected to biological water treatment by those microorganisms, it is less likely that algae and slime due to algae occur in the cooling water 90. Thus, decreases in thermal efficiency of the heat exchanger pipes can be prevented, so that an energy saving can be achieved.

In the case of this cooling apparatus, since there is no inflow of waste organic matters unlike the case of waste water treatment, microorganisms propagating in the cooling water 90 are lower in concentration than those of waste water treatment. As a result of such low concentration of microorganisms, microorganisms propagate concentratedly on the activated carbon 31. Then, by the microorganisms that have propagated concentratedly on the activated carbon 31 and been activated by micro/nanobubbles, the water treatment of the cooling water 90 is carried out. As a consequence, the cooling water 90 can be kept in a desirable state in the cooling tower 1, so that deposition of scale and slime can be suppressed.

### Fifth Embodiment

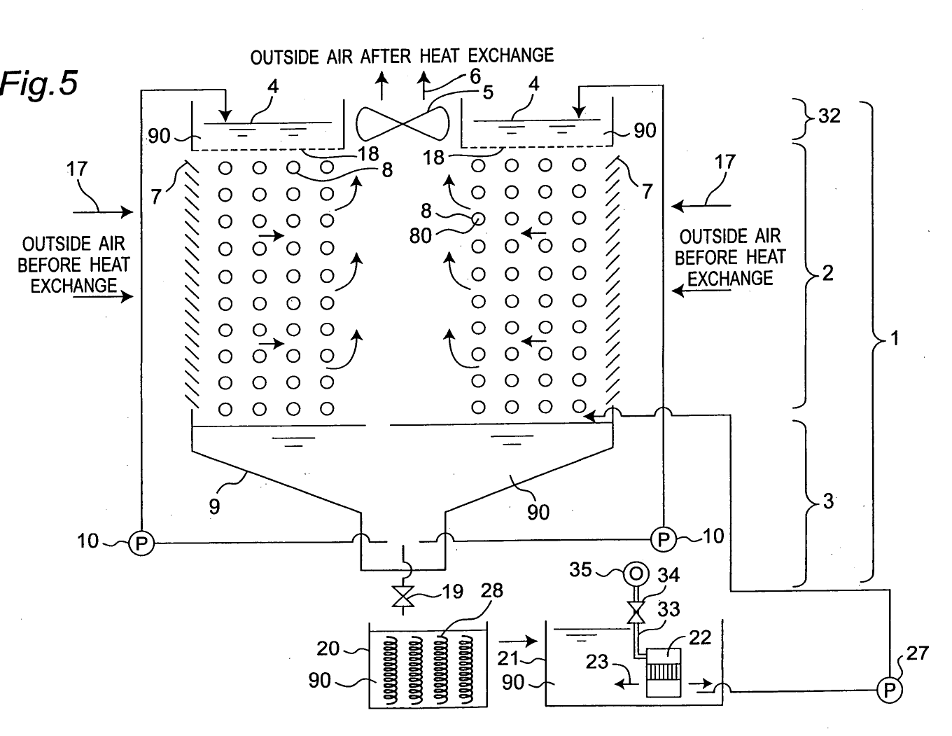

FIG. 5 schematically shows a construction of a cooling apparatus according to a fifth embodiment of the invention. In FIG. 5, the same components as in FIG. 1 are designated by the same reference numerals.

In the cooling apparatus of this fifth embodiment, in comparison to the first embodiment, there is provided no submerged pump type micro/nanobubble generator in the main water tank 9, but a water treatment tank 20 as a second auxiliary water tank and a micro/nanobubble generation tank 21 as a first auxiliary water tank are provided outside the cooling tower 1.

In the water treatment tank 20, a string-type polyvinylidene chloride material 28 as a microorganism carrier is housed. Into this water treatment tank 20, the cooling water 90 is introduced from the main water tank 9 through the piping below the main water tank 9 with the flow rate of the cooling water 90 regulated by a valve 19. Thus, the cooling water 90 is stored in the water treatment tank 20. The cooling water 90 of the water treatment tank 20 can be transferred to the micro/nanobubble generation tank 21 through unshown piping.

A submerged pump type micro/nanobubble generator 22 is placed in the micro/nanobubble generation tank 21. At a gas suction portion of the submerged pump type micro/nanobubble generator 22, an ozone generator 35 is integrally fitted via an ozone suction pipe 33 and a valve 34 for regulation of ozone generation amount. These components 22, 33, 34, 35 constitute a micro/nanobubble generation section.

As compared with a common micro/nanobubble generation system composed of a known micro/nanobubble generator (not shown) and a circulating pump (not shown), the micro/nanobubble generation section is simpler in its system and moreover capable of generating larger amounts of micro/nanobubbles on a water stream 23 by virtue of its adoption of the submerged pump type micro/nanobubble generator 22.

Outside the micro/nanobubble generation tank 21 is provided a circulating pump 27 as a second pump portion for sucking the cooling water 90 from the micro/nanobubble generation tank 21 and transferring the cooling water 90 to the main water tank 9 of the cooling tower 1.

In operation of the cooling apparatus, the sprinkler pump 10 is driven, so that the cooling water 90 is transferred from the main water tank 9 to the sprinkle water storage tank 4. The cooling water 90 temporarily stored in the sprinkle water storage tank 4 is sprinkled through the sprinkling ports 18 to the outer peripheral surfaces of the multiplicity of heat exchanger pipes 8. Concurrently with this, the fan 5 set in the upper portion 32 is rotated to make an upward air current. By this rotation of the fan 5, outside air before heat exchange 17 passes through the louver 7 in the intermediate portion 2 so as to be introduced to the zone where the heat exchanger pipes 8 are disposed. The cooling water 90 sprinkled to the outer peripheral surfaces of the heat exchanger pipes 8 absorbs heat from the water 80 within the heat exchanger pipes 8 while being cooled by direct contact with the outside air before heat exchange 17, i.e., with the atmospheric air. Thereafter, the cooling water 90 returns to the main water tank 9. In the way shown above, the cooling water 90 circulates through the upper portion 32, the intermediate portion 2 and the lower portion 3 of the cooling tower. The air, as outside air after heat exchange 6, is discharged upward of the cooling tower 1 by the rotation of the fan 5.

Thus, by the outside air, the water 80 within the heat exchanger pipes 8 is cooled via the cooling water 90.

Along with this, the circulating pump 27 is driven, so that the cooling water 90 of the main water tank 9 in the cooling tower 1 is introduced into the water treatment tank 20 via the valve 19. Then, the cooling water 90 is circulated through the water treatment tank 20, the micro/nanobubble generation tank 21 and the main water tank 9. Therefore, by the submerged pump type micro/nanobubble generator 22 generating ozone micro/nanobubbles in the cooling water 90 of the micro/nanobubble generation tank 21, ozone micro/nanobubbles can be made to be contained in the whole cooling water 90 that circulates along the circulating path through the upper portion 32, the intermediate portion 2 and the lower portion 3 of the cooling tower 1 as well as along the circulation path through the water treatment tank 20, the micro/nanobubble generation tank 21 and the main water tank 9. Thus, the cooling water 90 as a whole can be kept in a desirable state.

Also, the string-type polyvinylidene chloride material 28 as a microorganism carrier is housed in the water treatment tank 20. Therefore, as the operating time elapses, microorganisms propagate only at places in the two circulation paths of the cooling water 90 where the string-type polyvinylidene chloride material 28 housed in the water treatment tank 20 is present. These microorganisms are activated by micro/nanobubbles to produce an effect for subjecting the cooling water 90 to biological water treatment. Accordingly, it becomes possible to reduce water treatment chemicals for the cooling water 90. Also, since the cooling water 90 is subjected to biological water treatment by those microorganisms, it is less likely that algae and slime due to algae occur in the cooling water 90. Thus, decreases in thermal efficiency of the heat exchanger pipes can be prevented, so that an energy saving can be achieved.

### Sixth Embodiment

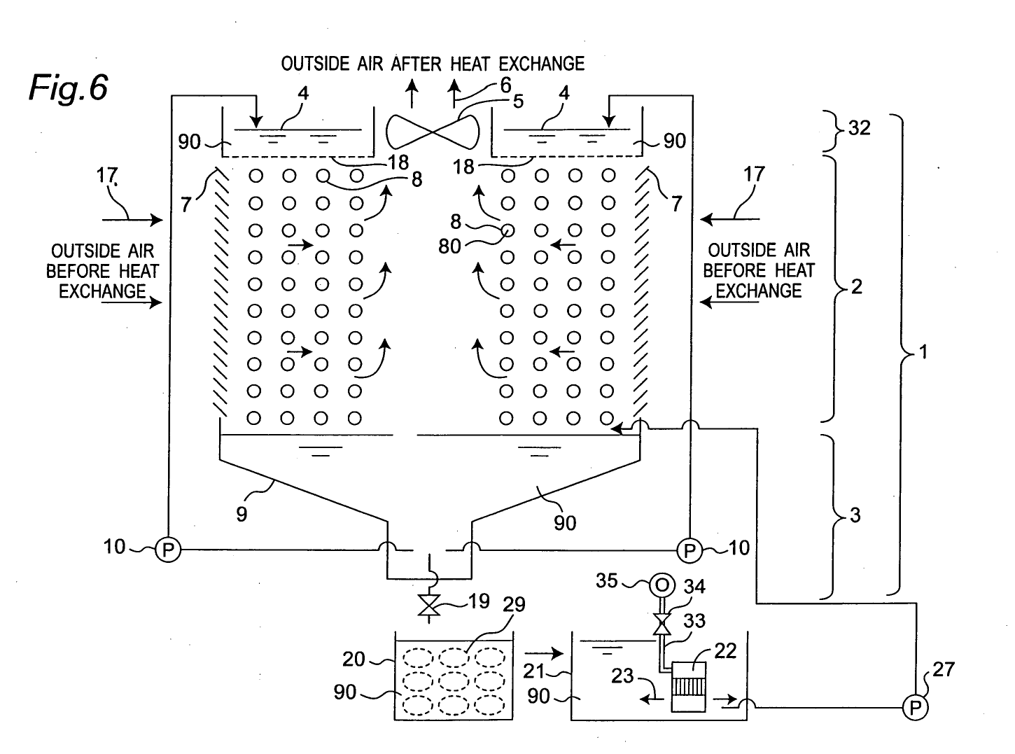

FIG. 6 schematically shows a construction of a cooling apparatus according to a sixth embodiment of the invention.

The cooling apparatus of this sixth embodiment differs from that of the fifth embodiment only in that a ring-type polyvinylidene chloride material 29 as a microorganism carrier is housed in the water treatment tank 20 instead of the string-type polyvinylidene chloride material 28. Therefore, in FIG. 6, the same components as in FIG. 5 are designated by the same reference numerals, and their detailed description is omitted.

In the cooling apparatus of this sixth embodiment, the ring-type polyvinylidene chloride material 29 as a microorganism carrier is housed in the water treatment tank 20. Therefore, as the operating time elapses, microorganisms propagate only at places in the two circulation paths of the cooling water 90 where the ring-type polyvinylidene chloride material 29 housed in the water treatment tank 20 is present. These microorganisms are activated by micro/nanobubbles to produce an effect for subjecting the cooling water 90 to biological water treatment. Accordingly, it becomes possible to reduce water treatment chemicals for the cooling water 90. Also, since the cooling water 90 is subjected to biological water treatment by those microorganisms, it is less likely that algae and slime due to algae occur in the cooling water 90. Thus, decreases in thermal efficiency of the heat exchanger pipes can be prevented, so that an energy saving can be achieved.

In addition, whether the string-type polyvinylidene chloride material 28 or the ring-type polyvinylidene chloride material 29 is chosen, actually, may be determined depending on treatment experiments.

### Seventh Embodiment

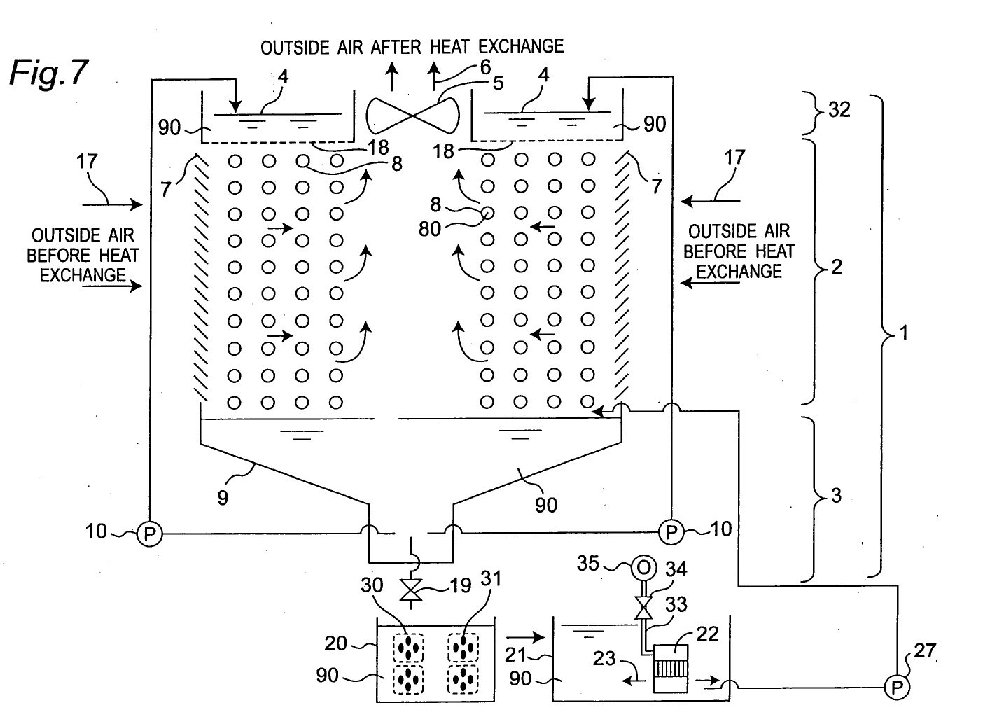

FIG. 7 schematically shows a construction of a cooling apparatus according to a seventh embodiment of the invention.

The cooling apparatus of this seventh embodiment differs from that of the fifth embodiment only in that activated carbon 31 as a microorganism carrier contained in meshed bags 30 is housed in the water treatment tank 20 instead of the string-type polyvinylidene chloride material 28. Therefore, in FIG. 7, the same components as in FIG. 5 are designated by the same reference numerals, and their detailed description is omitted.

In the cooling apparatus of this seventh embodiment, the activated carbon 31 as a microorganism carrier is housed in the water treatment tank 20. Therefore, as the operating time elapses, microorganisms propagate only at places in the two circulation paths of the cooling water 90 where the activated carbon 31 housed in the water treatment tank 20 is present. These microorganisms are activated by micro/nanobubbles to produce an effect for subjecting the cooling water 90 to biological water treatment. In particular, it is a large effect that the activated carbon 31 adsorbs organic matters in the cooling water 90 and allows the adsorbed organic matters to be thereafter decomposed by the microorganisms that have propagated in the activated carbon. Accordingly, it becomes possible to reduce water treatment chemicals for the cooling water 90. Also, since the cooling water 90 is subjected to biological water treatment by those microorganisms, it is less likely that algae and slime due to algae occur in the cooling water 90. Thus, decreases in thermal efficiency of the heat exchanger pipes can be prevented, so that an energy saving can be achieved.

In addition, whether the string-type polyvinylidene chloride material 28 or the activated carbon 31 is chosen, actually, may be determined depending on treatment experiments.

### Eighth Embodiment

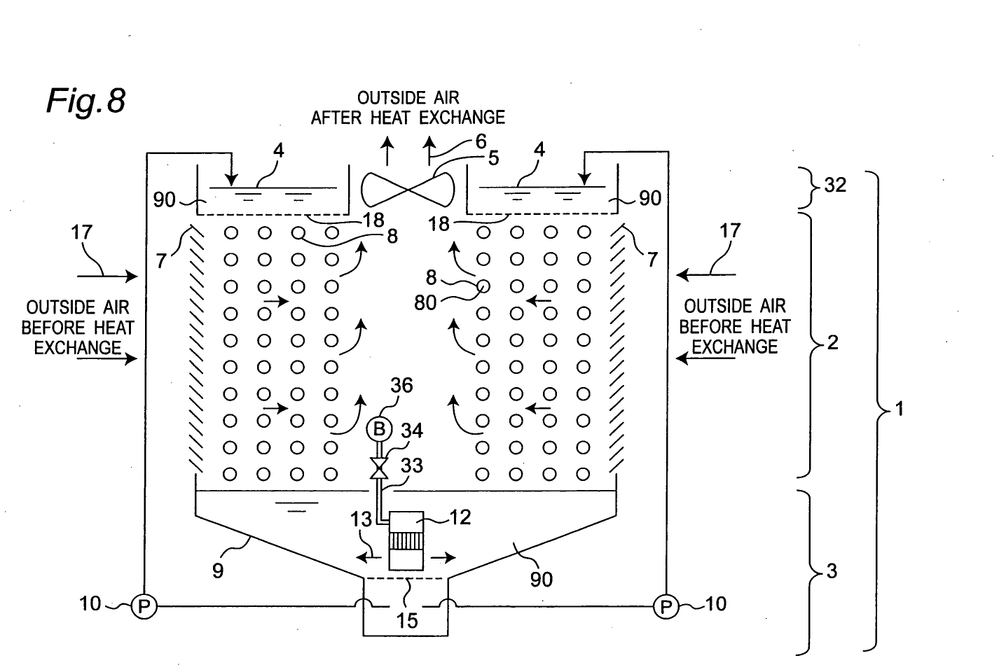

FIG. 8 schematically shows a construction of a cooling apparatus according to an eighth embodiment of the invention.

The cooling apparatus of this eighth embodiment differs from that of the first embodiment only in that the ozone generator 35 is replaced with a blower 36. Therefore, in FIG. 8, the same components as in FIG. 1 are designated by the same reference numerals, and their detailed description is omitted.

In the cooling apparatus of this eighth embodiment, since the blower 36 is used instead of the ozone generator 35 of the first embodiment, air micro/nanobubbles are contained in the cooling water 90 in the cooling tower 1. In the case of air micro/nanobubbles, although the bactericidal effect for the cooling water 90 is weak, oxidizability of micro/nanobubbles for the cooling water 90 allows the water quality to be maintained. Also, it is possible to activate the microorganisms propagating in the cooling water 90 to carry out the water treatment for the cooling water 90. Thus, the amount of use of water treatment chemicals can be reduced.

### EXAMPLE 1

The cooling apparatus of the first embodiment shown in FIG. 1 was actually manufactured, and subjected to verification tests on its effects.

In that cooling apparatus, the sprinkle water storage tank 4 was set to a capacity of about 0.3 m³, the intermediate portion 2 was set to a capacity of about 4 m³, and the main water tank 9 was set to a capacity of about 1 m³. Also, the sprinkler pump 10 was set to such a discharge rate of flow that the amount of circulating water for the main water tank 9 would be 1 rotation per hour. Further, the ozone generator 35 was set to such performance that the ozone concentration in the main water tank 9 would fall within a range of 2 ppm to 5 ppm. Then, with industrial water introduced as the cooling water 90, the cooling apparatus was subjected to a 1-month trial operation.

After the trial operation, the amount of occurrence of slime was compared between the cooling apparatus and a conventional cooling tower. As a result, the amount of occurrence of slime in the manufactured cooling apparatus was about 20% of that of the conventional cooling tower. Thus, according to the present invention, a preferable result was obtained.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A cooling water reforming method including a step of making ozone micro/nanobubbles contained in cooling water in a cooling tower.

2. A cooling apparatus comprising an ozone micro/nanobubble generation section for generating ozone micro/nanobubbles in cooling water in a cooling tower so as to make ozone micro/nanobubbles contained in the cooling water.

3. The cooling apparatus as claimed in claim 2, wherein
the ozone micro/nanobubble generation section comprises an ozone generator for generating ozone, and a micro/nanobubble generator for generating ozone micro/nanobubbles in the cooling water by using the ozone.

4. The cooling apparatus as claimed in claim 3, wherein
the cooling tower comprises: a sprinkle water storage tank, placed in an upper portion, for storing the cooling water; a water sprinkling portion, placed in an intermediate portion, for sprinkling cooling water derived from the sprinkle water storage tank; and a main water tank, placed in a lower portion, for collecting and storing cooling water sprinkled by the water sprinkling portion, the cooling apparatus further comprising:
a first pump portion for transferring the cooling water of the main water tank to the sprinkle water storage tank, wherein
the micro/nanobubble generator generates ozone micro/nanobubbles in the cooling water of the main water tank.

5. The cooling apparatus as claimed in claim 2, wherein
the cooling tower comprises: a sprinkle water storage tank, placed in an upper portion, for storing the cooling water; a water sprinkling portion, placed in an intermediate portion, for sprinkling cooling water derived from the sprinkle water storage tank to outer peripheral surfaces of a plurality of heat exchanger pipes; and a main water tank, placed in a lower portion, for collecting and storing cooling water sprinkled by the water sprinkling portion, the cooling apparatus further comprising:
a first pump portion for transferring the cooling water of the main water tank to the sprinkle water storage tank, wherein
a microorganism carrier for allowing microorganisms to propagate is housed in each of the sprinkle water storage tank and the main water tank.

6. The cooling apparatus as claimed in claim 5, wherein
the microorganism carrier is a string-type or ring-type polyvinylidene chloride material.

7. The cooling apparatus as claimed in claim 5, wherein
the microorganism carrier is activated carbon contained in a meshed bag.

8. The cooling apparatus as claimed in claim 3, wherein
the cooling tower comprises: a sprinkle water storage tank, placed in an upper portion, for storing the cooling water; a water sprinkling portion, placed in an intermediate portion, for sprinkling cooling water derived from the sprinkle water storage tank; and a main water tank, placed in a lower portion, for collecting and storing cooling water sprinkled by the water sprinkling portion, the cooling apparatus further comprising:
a first pump portion for transferring the cooling water of the main water tank to the sprinkle water storage tank,
a first auxiliary water tank placed outside the cooling tower, and
a second pump portion for circulating the cooling water between the cooling tower and the first auxiliary water tank, wherein
the micro/nanobubble generator generates ozone micro/nanobubbles in the cooling water of the first auxiliary water tank.

9. The cooling apparatus as claimed in claim 8, further comprising
a second auxiliary water tank interposed on a circulation path of the cooling water between the cooling tower and the first auxiliary water tank, wherein
a microorganism carrier for allowing microorganisms to propagate is housed in the second auxiliary water tank.

10. The cooling apparatus as claimed in claim 9, wherein
the microorganism carrier is a string-type or ring-type polyvinylidene chloride material.

11. The cooling apparatus as claimed in claim 9, wherein
the microorganism carrier is activated carbon contained in a meshed bag.

12. The cooling apparatus as claimed in claim 3, wherein
the micro/nanobubble generator is a submerged pump type micro/nanobubble generator.

13. The cooling apparatus as claimed in claim 12, wherein
the ozone generator is fitted at a gas suction portion of the submerged pump type micro/nanobubble generator.
